(19) United States
(12) Patent Application Publication
(10) Pub. No.: US 2017/0109438 A1
(43) Pub. Date: Apr. 20, 2017

(54) CONTEXTUAL FEATURE SELECTION WITHIN AN ELECTRONIC DATA FILE

(71) Applicant: EMEGABOOK LLC, Tucson, AZ (US)

(72) Inventor: Ellyn Janet Wilson Oliver, San Diego, CA (US)

(21) Appl. No.: 15/294,250

(22) Filed: Oct. 14, 2016

Related U.S. Application Data
(60) Provisional application No. 62/243,324, filed on Oct. 19, 2015.
(60) Provisional application No. 62/325,501, filed on Apr. 21, 2016.

(51) Int. Cl. G06F 17/30; G06F 17/27

(52) U.S. Cl. CPC G06F 17/30719; G06F 17/30675; G06F 17/277

(57) ABSTRACT

A system and method for feature selection within an electronic data file includes gathering a plurality of features from a first electronic data file. A relevancy of each of the plurality of features of the first electronic data file is determined, wherein the relevancy is expressed numerically. At least one of the plurality of features meeting a predetermined relevancy numeric is selected to create a summary file for one feature of the first electronic data file. The one feature of the first electronic data file is isolated with features of other electronic data files. A feature matrix is created for each electronic data file, the feature matrix having the plurality of features for each electronic data file. A connection between one of the plurality of features within the feature matrix is identified with a searched string based on a relevancy of the plurality of features to the electronic data file.

### CROSS REFERENCE TO RELATED APPLICATION

This application claims benefit of U.S. Provisional Application Ser. No. 62/243,324 entitled, “Story Driven Advertising” and filed Oct. 19, 2015 and U.S. Provisional Application Ser. No. 62/325,501 entitled, “System and Method for Feature Selection and Classification in an Electronic Data File” and filed Apr. 21, 2016, the entire disclosures of which are incorporated herein by reference.

### FIELD OF THE DISCLOSURE

The present disclosure is generally related to electronic data files and more particularly is related to contextual feature selection within an electronic data file.

### BACKGROUND OF THE DISCLOSURE

The increasing prevalence of portable electronic devices, such as smart phones, tablets, and compact computers has effected a significant increase in the development of media and content for users to enjoy on his or her devices. This media and content is stored as digitized data often on user-accessible servers, e.g., the Cloud, where it can be accessed and downloaded by users. One type of media or content is the electronic book, or eBook, which is widely used to read novels, magazines, and other written works on an electronic device. The eBook is growing in popularity and rapidly becoming a preferred form of books by many readers.

There are known, commercially available techniques for embedding advertisements in electronic text in some applications. For example, advertising banners are often provided on webpages. Tithe webpage receives significant traffic, such advertising banners can be an effective form of advertising. Further, revenues can be generated for the webpage owner by charging the advertiser for hosting the advertisement on the webpage. However, the use of advertising in electronic texts has shortcomings, namely, the difficultly in pairing suitable advertisements to the appropriate user. When advertisements for a particular product or service are directed to a reader who has little interest in that product or service, the successfulness of the embedded advertisement is significantly low. In turn, this problem lessens an advertiser's interest in investing in embedded advertisements.

Thus, a heretofore unaddressed need exists in the industry to address the aforementioned deficiencies and inadequacies.

### SUMMARY OF THE DISCLOSURE

Embodiments of the present disclosure provide a system and method for feature selection within an electronic data file. In this regard, one embodiment of such a method, among others, can be broadly summarized by the following steps: identifying a plurality of features from a first electronic data file using textual data from the first electronic data file; identifying a relevancy of each of the plurality of features of the first electronic data file, wherein the relevancy is expressed numerically; selecting at least one of the plurality of features meeting a predetermined relevancy numeric, thereby creating a summary file for the at least one of the plurality of features of the first electronic data file; isolating the at least one feature of the first electronic data file with features identified from other electronic data files using textual data within the other electronic data files; creating a feature matrix for each electronic data file to correlate the plurality of features to each electronic data file; and identifying at least one connection between one of the plurality of features within the feature matrix with a searched string based on a relevancy of the plurality of features to the electronic data file.

Embodiments of the present disclosure provide a computerized system of feature selection within an electronic data file. Briefly described, in architecture, one embodiment of the system, among others, can be implemented as follows. The computerized system has a processor capable of performing the steps of identifying a plurality of features from a first electronic data file using textual data from the first electronic data file; identifying a relevancy of each of the plurality of features of the first electronic data file, wherein the relevancy is expressed numerically; selecting at least one of the plurality of features meeting a predetermined relevancy numeric, thereby creating a summary file for the at least one of the plurality of features of the first electronic data file; isolating the at least one feature of the first electronic data file with features identified from other electronic data files using textual data within the other electronic data files; creating a feature matrix for each electronic data file to correlate the plurality of features to each electronic data file; and identifying at least one connection between one of the plurality of features within the feature matrix with a searched string based on a relevancy of the plurality of features to the electronic data file.

The present disclosure can also be implemented as a method of contextual feature selection within a computerized eBook text file. In this regard, one embodiment of such a method, among others, can he broadly summarized by the following steps: identifying a plurality of features from a plurality of eBook text files, respectively, using textual data from each of the plurality of eBook text files, wherein the plurality of features are one of: an entity, a keyword, a concept, a relation, and a taxonomy term; calculating a numerical relevancy score for each of the plurality of features of each of the plurality of eBook text files relative to a discrete portion each of the plurality of eBook text files, respectively; creating a summary file each of the plurality of eBook text files and for each of the plurality of features having a numerical relevancy score greater than a predetermined relevancy numeric; isolating at least one of the plurality of features of one of the plurality of eBook text files; correlating the at least one isolated feature of the one eBook with other isolated features of other eBooks based on a data type of the isolated features to thereby create a feature matrix for each of the plurality of eBook text files; and identifying at least one connection between one of the isolated features within the feature matrix with a searched string based on a relevancy of the isolated feature to the discrete portion of the eBook text file.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart illustrating a method of feature selection within an electronic data file, in accordance with a first exemplary embodiment of the present disclosure.

FIG. 2 is an image of code expressions used in the method of feature selection within the electronic data file of FIG. 1, in accordance with the first exemplary embodiment of the present disclosure.

FIG. 3 is an image of code expressions used in the method of feature selection within the electronic data file of FIG. 1, in accordance with the first exemplary embodiment of the present disclosure.

FIG. 4 is an image of output data lines used in the method of feature selection within the electronic data file of FIG. 1, in accordance with the first exemplary embodiment of the present disclosure.

FIG. 5 is an image of code expressions for formatting data used in the method of feature selection within the electronic data file of FIG. 1, in accordance with the first exemplary embodiment of the present disclosure.

FIG. 6 is an image of code expressions for appending the multidimensional list used in the method of feature selection within the electronic data file of FIG. 1, in accordance with the first exemplary embodiment of the present disclosure.

FIG.7 is an image of code expressions for mining a specific data entry from the list of information used in the method of feature selection within the electronic data file of FIG. 1, in accordance with the first exemplary embodiment of the present disclosure.

FIG. 8 is an image of code expressions of the information appended to an eBook's summary file used in the method of feature selection within the electronic data file of FIG. 1, in accordance with the first exemplary embodiment of the present disclosure.

FIG. 9 is an image of code expressions of a profanity filter used in the method of feature selection within the electronic data file of FIG. 1, in accordance with the first exemplary embodiment of the present disclosure.

FIG. 10 is an image of code expressions of a profanity filter count used in the method of feature selection within the electronic data file of FIG. 1, in accordance with the first exemplary embodiment of the present disclosure.

FIG. 11 is an image of code expressions for extracting syntactic and lexical features used in the method of feature selection within the electronic data file of FIG. 1, in accordance with the first exemplary embodiment of the present disclosure.

FIG. 12 is an image of code expressions outlining potential algorithms used in the method of feature selection within the electronic data file of FIG. 1, in accordance with the first exemplary embodiment of the present disclosure.

FIG. 13 is an image of code expressions for obtaining a count of word occurrences used in the method of feature selection within the electronic data file of FIG. 1, in accordance with the first exemplary embodiment of the present disclosure.

FIGS. 14-15 are images of code expressions of performance of the machine learning system, in accordance with the first exemplary embodiment of the subject disclosure.

FIG. 16 is a flowchart illustrating a method of the creation of feature matrices and the classifications used on them, to be saved as data, in accordance with the first exemplary embodiment of the present disclosure.

FIG. 17 is a schematic diagram of a feature matrix for use in the method of feature selection and classification within an electronic data file, in accordance with the first exemplary embodiment of the present disclosure.

FIG. 18 is an image of code expressions for prompting users for desired specifications, used in the method of feature selection within the electronic data file of FIG. 16, in accordance with the first exemplary embodiment of the present disclosure.

FIG. 19 is an image of code expressions for filtering out graphic or profane matches, used in the method of feature selection within the electronic data file of FIG. 16, in accordance with the first exemplary embodiment of the present disclosure.

FIG. 20 is an image of code expressions for filtering out graphic matches, used in the method of feature selection within the electronic data file of FIG. 16, in accordance with the first exemplary embodiment of the present disclosure.

FIG. 21 is an image of code expressions for extracting the entities from the summary files used in the method of feature selection within the electronic data file of FIGS. 1 and 16, in accordance with the first exemplary embodiment of the present disclosure.

FIG. 22 is an image of code expressions for tokenizing each group of data types used in the method of feature selection within the electronic data file of FIG. 16, in accordance with the first exemplary embodiment of the present disclosure.

FIG. 23 is an image of code expressions for this process used in the method of feature selection within the electronic data file of FIG. 16, in accordance with the first exemplary embodiment of the present disclosure.

FIG. 24 is an image of code expressions for accessing and checking for each entity item relative to the master list used in the method of feature selection within the electronic data file of FIG. 16, in accordance with the first exemplary embodiment of the present disclosure.

FIG. 25 is an image of code expressions for combining each data type matrix into a single matrix, used in the method of feature selection within the electronic data file of FIG. 16, in accordance with the first exemplary embodiment of the present disclosure.

FIG. 26 is an image of code expressions for the overall process of calling the machine learning functions for each of the taxonomy terms, used in the method of feature selection within the electronic data file of FIG. 16, in accordance with the first exemplary embodiment of the present disclosure.

FIG. 27 is an image of code expressions for a function that is called to collect synonyms, used in the method of feature selection within the electronic data file of FIG. 16, in accordance with the first exemplary embodiment of the present disclosure.

FIG. 28 is an image of code expressions for a function to create a target matrix, used in the method of feature selection within the electronic data file of FIG. 16, in accordance with the first exemplary embodiment of the present disclosure.

FIG. 29 is an image of code expressions for Logistic Regression used in the method of feature selection within the electronic data file of FIG. 16, in accordance with the first exemplary embodiment of the present disclosure.

FIG. 30 is an image of code expression outputs for initial tests of various models used in the method of feature selection within the electronic data file of FIG. 16, in accordance with the first exemplary embodiment of the present disclosure.

FIG. 31 is an image of code expression for accessing text files for chapters with indexes indicating a positive match, used in the method of feature selection within the electronic data file of FIG. 16, in accordance with the first exemplary embodiment of the present disclosure.

FIG. 32 is an image of code expression for processing a word sense, used in the method of feature selection within the electronic data file of FIG. 16, in accordance with the first exemplary embodiment of the present disclosure.

FIG. 33 is an image of code expression outputs of the process of FIG. 32, in accordance with the first exemplary embodiment of the present disclosure.

FIG. 34 is an image of code expression for a single search term used in the method of feature selection within the electronic data file, in accordance with the first exemplary embodiment of the present disclosure.

FIG. 35 is an image of code expression for potential audience type term used in the method of feature selection within the electronic data file, in accordance with the first exemplary embodiment of the present disclosure.

FIG. 36 is an image of code expression outputs for audience type determination used in the method of feature selection within the electronic data file, in accordance with the first exemplary embodiment of the present disclosure.

FIG. 37 is a block flowchart illustrating a method of feature selection and classification within an electronic data file, in accordance with the first exemplary embodiment of the disclosure.

### DETAILED DESCRIPTION

The subject disclosure is directed to a system and method for feature selection and classification within electronic data files, commonly, an electronic book (eBook) or similar data file. The eBook file may include any type of file format, commonly the EPUB format due to its popularity and prevalence. Other formats may include Broadband eBooks (BBeB), .doc or .docx files, eReader files (.pdb), FictionBook (.fb2), Founder Electronics (.xeb, .ceb), as well as other text data files not explicitly identified herein.

Taking the eBook as the exemplary data file (hereinafter, referred to as “eBook”, “eBook text file”, or “book”), as a general overview, the subject disclosure may allow for the identification of features within a body of text of that eBook. Once identified, those features may be processed and organized into a usable matrix which can be used to identify features within other eBooks that may be similar in terms of concepts, plots, characters, etc. This data can be used to determine audience type for a particular eBook, such as to leverage the context of the eBook to create a profile of the user through their use of that eBook and others. This correlation between the user type and the eBook can be beneficial in a number of ways. For example, knowing the audience type of a particular eBook enables the possibility of making a suggestion to that user on other, similar eBooks, or making a suggestion to other users who might have similar interests. Further, being able to identify audience types based on interests can be beneficial in the advertising field where advertisements directed to specific user types can he made with greater success than conventional means.

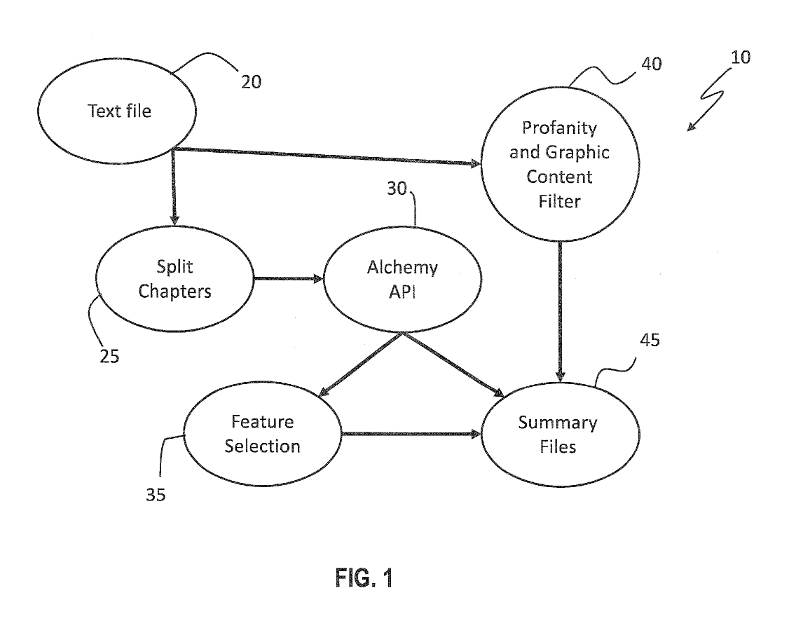

FIG. 1 is a flowchart 10 illustrating a method of feature selection within an electronic data file, in accordance with a first exemplary embodiment of the present disclosure. In particular, FIG. 1 illustrates a method of preprocessing an electronic data file. The method may begin with the electronic data file having text, such as the eBook text file, as shown at block 20. Since most eBook text files are large, the eBook text file can be split into chapters to lower the amount of data that is processed at a given time, as indicated at block 25. Additionally, the eBook text file may be split into smaller units that are not based specifically by chapter, but splitting by chapters may be beneficial for advertisement placements at defined locations within the text file. cBooks that are short and may not have chapters or large data sizes may not be required to be split into smaller units.

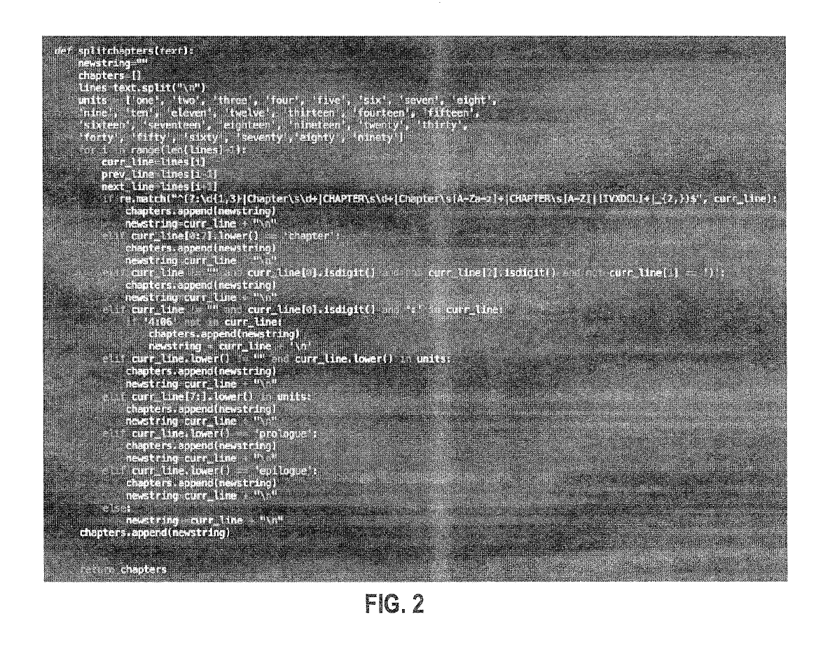

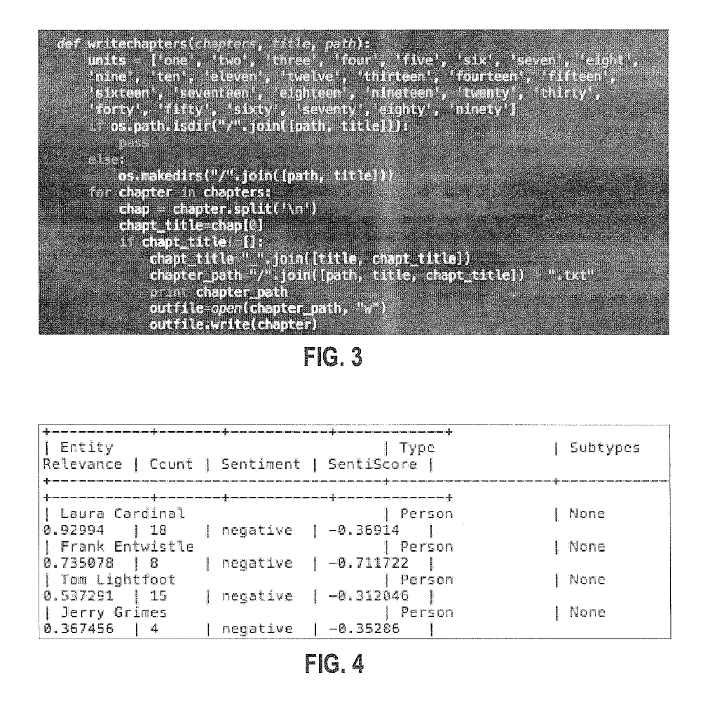

FIG. 2 is an image of code expressions used in the method of feature selection within the electronic data file of FIG. 1, in accordance with the first exemplary embodiment of the present disclosure. Specifically, FIG. 2 illustrates expressions used in order to locate where chapters of a text file were beginning. As can be seen, each eBook's text file can first be split into discrete portions, such as chapters or more commonly, lines. These lines are then iterated through and compared to several regular expressions. The regular expressions may be compiled through knowledge of the book files and through testing. Once the eBook files have been split into individual chapters, for example, using the regular expressions of FIG. 2, and saved as a list of entries, separate files may be created for every entry. FIG. 3 is an image of code expressions used in the method of feature selection within the electronic data file of FIG. 1, in accordance with the first exemplary embodiment of the present disclosure. Specifically, FIG. 3 illustrates how the eBook text file for each chapter can be created. By accessing each saved entry, a new text file can be created. The name of each file may be created by joining the book title that it originated from with the line denoting the beginning of the chapter. Once the file is created, the entry for that chapter may be written into it and saved.

Referring back to FIG, 1, at block 30, the chapters of the eBook text file are processed using Alchemy API software or similar software, which analyzes the text within the eBook text file to gather or select features of the eBook, as indicated at block 35. The features, for example, may include any type of trait, characteristic, or identifying aspect of the eBook. For example, the features may be entities of the eBook, which may include characters, people, settings, objects, or other entities identified with a proper noun. Other features may include keywords, concepts, relations, and taxonomy terms relevant to a portion of the text being analyzed. Other features may include other aspects of the eBook not explicitly identified here, but considered within the scope of the present disclosure. The features that are gathered may offer varying levels of specificity on their relevance to the eBook. For example, entities and keywords of the eBook, as well as brand names used in the eBook, may be some of the most specific pieces of data that the Alchemy API software gathers, due to the fact that these features arc indicative of specific data themselves, e.g., a character name is indicative of that character. Other features, such as concepts and taxonomy terms may be more general due to the possibility of interpretations in analyzing those terms. The Alchemy API software may output data lines, as shown in FIG. 4, which is an image of output data lines used in the method of feature selection within the electronic data file of FIG. 1, in accordance with the first exemplary embodiment of the present disclosure. As shown in FIG. 4, the features are the names, “Laura Cardinal”, “Frank Entwistle”, “Tom Lightfoot”, and “Jerry Grimes”, which are identified as people.

In addition to the identification of the feature within the eBook or a chapter thereof, the output of the Alchemy API software may provide an identification of a relation and relevancy of each feature of the text. For example, a ‘Sentiscore’ (‘Sentiment’) or relation score may be extracted based on the piece of data's positive or negative relation to text around it. For example, based on the text surrounding a keyword, the keyword may receive a score between −1 and +1, with +1 being the most positive relationship to the surrounding text and −1 being the most negative relationship to the surrounding text. The keyword (or feature of the text, or other piece of data) may then be filter with the Sentiscore by setting a threshold. For example, a user may specify that −0.3 is the least positive relation that the user will accept. Data with a Sentiscore that falls below this threshold can be excluded from the rest of the process. This thresholding of data using the Sentiscore can help narrow down large quantities of data, such that the most relevant data can be extracted.

The relevancy of the feature may also be used to narrow down the field of identified features to those that are most central to the text. The relation or relevancy may be expressed numerically, such as with a relation score or relevancy score, or with other data. In the data line examples of FIG. 4, the first decimal number ('0.92994) is a relevancy numeric which is representative of the relevance of the identified feature (‘Laura Cardinal’) and the number of times in which it is found (‘18’). The data line also shows the sentiment of the relation (‘negative’) and the relation score (−0.36914).

The occurrence of each feature within the text may be organized relative to other features using the relevancy numeric. Once each of the features have been identified and organized according to a relevancy numeric, it is possible to segregate each feature into broader classes of relevancy. One method is to use a threshold or cutoff number that can be used to parse out relevancies which fall below a predetermined level, or it is possible to sort the features by relevancy and limit the number received. For example, with features identified as entities, keeping the first 15 entities may generally parse out those entities with relevancies that are below 30-40%.

A Python program can be used to retrieve data from Alchemy API software. This Python program iterates through all of the chapter files that are in the library, making calls to the Alchemy API software for each individual chapter. For each chapter, a call to the system for each data type must then be made. Once it has been established that the data type exists for the chapter, the returned data may be formatted.

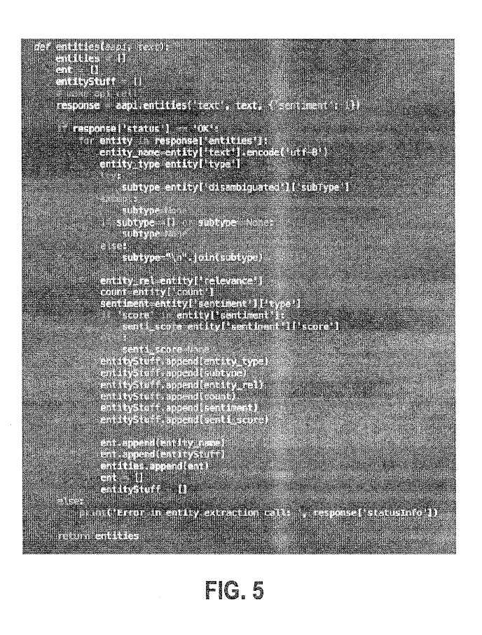

FIG. 5 is an image of code expressions for formatting data used in the method of feature selection within the electronic data file of FIG. 1, in accordance with the first exemplary embodiment of the present disclosure. In formatting the data, it may be beneficial to create an initial list of all information about each piece of data and eventually append all information about each piece of data into a multidimensional list. This way, when this data is accessed later in the process, it can be assured that the relation or relevancy scores will always be in the same place regarding the piece of data that it refers to. As shown, FIG. 5 focuses on the calls made for entities. In addition to the below function, similar functions may be created for every other data type that is able to be retrieved.

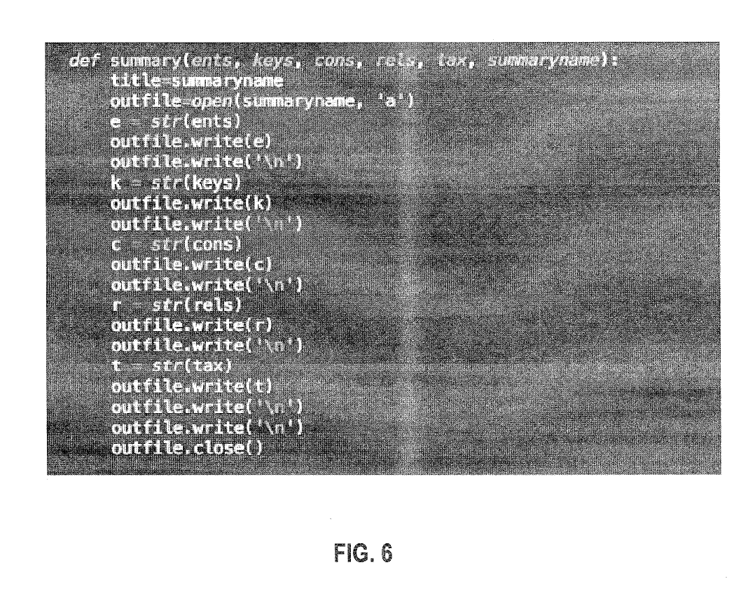

Accordingly, once an initial list has been created for each data type within a chapter, it may then be appended together into a new, larger, multidimensional list. This multidimensional list may allow for all information about the data in a specific chapter to be easily accessed at once. The large list for each chapter may then be appended to the summary file for the book that it originated from. FIG. 6 is an image of code expressions for appending the multidimensional list used in the method of feature selection within the electronic data file of FIG. 1, in accordance with the first exemplary embodiment of the present disclosure. Once all chapters belonging to a particular book have been added to its summary file, the result is a file of lists with each list therein corresponding to a specific chapter.

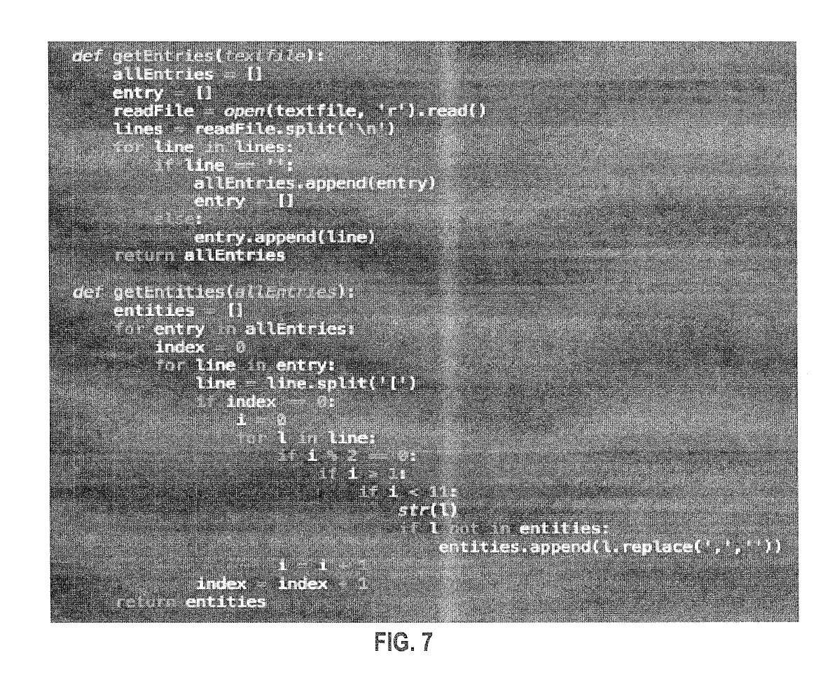

Because the eBook text files are separated into chapters to enhance the processing through the Alchemy API software, measures should he taken to create overall data that can be used in making assignments for eBooks holistically. In order to do this, new functions can be used that could read in all of the features that arc included in a book's summary file, and choose the most relevant features for each data type. Once the program delves into a particular eBook's summary file, it may then be split into entries. This is done by putting each list inside the program into a single entry. Each type of data is then accessed for every chapter's entry. Because the amount of data returned for each type is different, the number of most relevant entries retrieved for each is different. The distribution is as follows: 10 entities, 20 keywords, and six concepts. All relations and taxonomy terms may be included, since there are relatively few of them. Taxonomy terms may he reserved for chapters, as they vary greatly. FIG.7 is an image of code expressions for mining a specific data entry from the list of information used in the method of feature selection within the electronic data file of FIG. 1, in accordance with the first exemplary embodiment of the present disclosure. Entities are used as the example in FIG. 7.

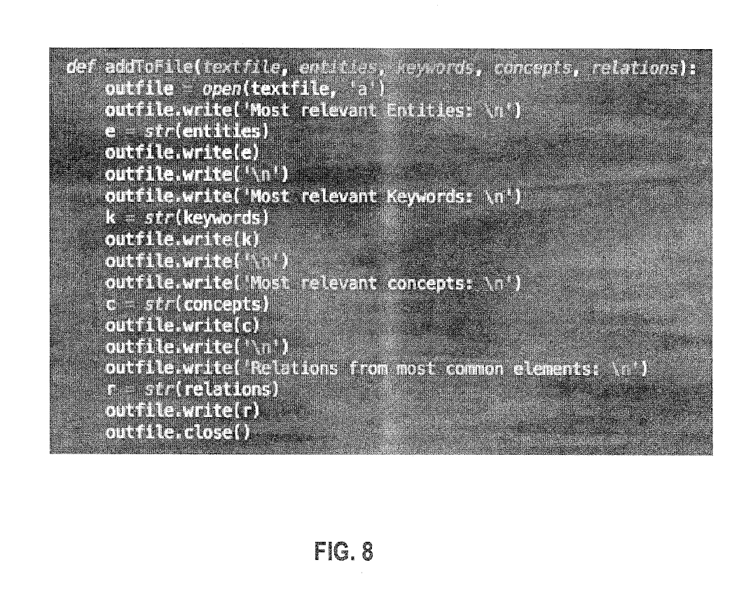

Because the order that the calls were made in the previous functions is known, the entity list within the entry can be accessed with ease. After the desired list has been located, it then must be split into the lists, which correspond to each entity. Within these first ten lists, the first entry may be extracted. It is then possible to confidently assume that the first ten lists will be the most relevant to the content in the eBook text file because the Alchemy API software returns data in order of their relevancy scores. For each data type, this information is saved into a new list. After all types of data have been accessed, the new data for the overall book can be appended to that eBook's summary file. For readability in the summary file, descriptions may be added of what the data in the following line would be. FIG. 8 is an image of code expressions of the information appended to an eBook's summary file used in the method of feature selection within the electronic data file of FIG. 1, in accordance with the first exemplary embodiment of the present disclosure.

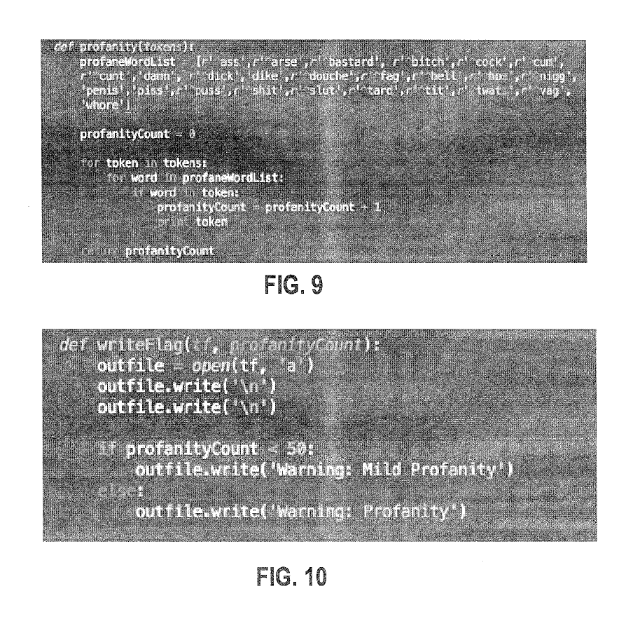

Referring back to FIG. 1, concurrently with processing the eBook file through the Alchemy API software, the eBook file may be independently processed through a profanity filter to filter out instances of profanity, potentially graphic content, or other appearances of undesired text within the eBook file, as shown at block 40. FIG. 9 is an image of code expressions of a profanity filter used in the method of feature selection within the electronic data file of FIG. 1, in accordance with the first exemplary embodiment of the present disclosure. As shown, a regular expression format may be used to list common profanities to the English language. By using a regular expression, it may be possible to account for instances of the profanities that included more than just the root word. This may also keep the list as short as possible. In order to find the profanities within the text of the books, each eBook text file may need to he opened and tokenized. To preprocess the eBook text files, a natural language toolkit (NLTK) tokenizer may be used. The tokens may then be compared to the regular expression list to find any possible matches. If a book has a match, its “profanity count” may be incremented by one. The final number of matches may then be returned to the main function.

FIG. 10 is an image of code expressions of a profanity filter count used in the method of feature selection within the electronic data file of FIG. 1, in accordance with the first exemplary embodiment of the present disclosure. Specifically, FIG. 10 represents what may then be done with the final number of profanities found within each eBook text file. The profanity filter may take in the name of an eBook's summary file and the total number of profanities found. It then writes a warning for mild profanity in the summary file for a count of 50 or less instances of profanity, and a general profanity warning for books with a profanity count higher than that. eBooks with less than 50 occurrences of profanity may have a tendency to use less severe words from the list, which is one reason for using two general types of profanity warnings. If no matches of profane material were found, no warning is written to the file.

A more complicated task than ascertaining whether an eBook text file contains clear profanity is determining whether there is graphically violent or sexually explicit content in the eBook text file without needing a human being to read each text file individually. Many advertisers may wish not to incorporate their advertisements in chapters or books that contain explicit or violent material. And, it is not practical for human beings to carefully read through every book in the library as the company grows and make a determination as to whether the book contains graphic or violent material. However, it is possible to implement machine learning as a solution for this task.

In creating the feature matrix for all chapters, discussed later, including the graphic ones that were added for training purposes, it may be necessary to use both syntactic and lexical features. Syntactic features may be extracted by first being run through a speech tagger within a natural language tool kit. Then, it is possible to save the ratio of nouns to verbs, nouns to adjectives, verbs to adverbs, and overall sentence length and verb counts for each chapter. FIG. 11 is an image of code expressions for extracting syntactic and lexical features used in the method of feature selection within the electronic data file of FIG. 1, in accordance with the first exemplary embodiment of the present disclosure. While syntactic features used may remain constant throughout development, the lexical features may change.

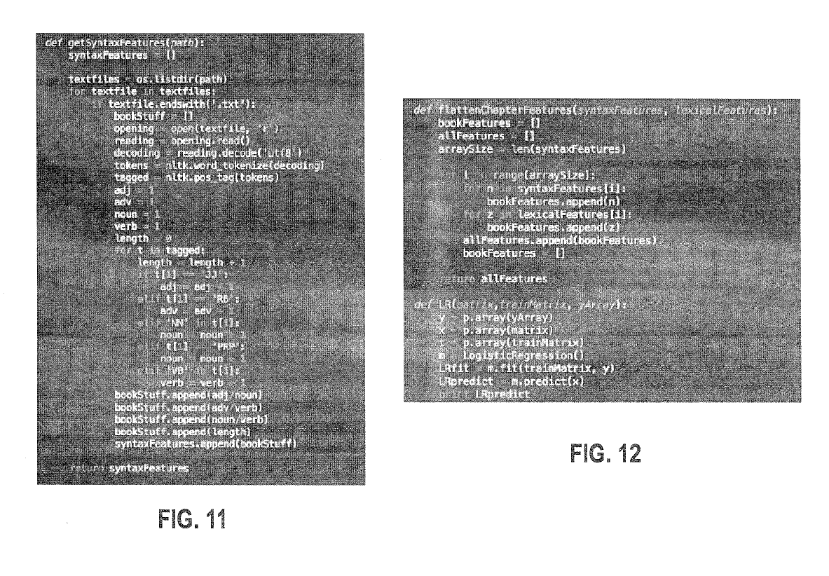

To initiate the machine learning process, it may first be necessary to identify chapters or passages from other books that contained trustworthy examples of graphic content. For example, using a small sample of books in the library, it may he possible to identify negative results for graphic content in this sample of books. The select chapters of these books may be gathered and downloaded. Depending on one's familiarity with the small sample of books currently in the system, it may be predicted that the initial training dataset is likely to be primarily positive or negative. A plurality of algorithms may be employed in order to determine which algorithm would best fit the selected sample of data. The algorithms may include Logistic Regression, Gaussian Naïve Bayes, and Multinomial Naïve Bayes. FIG. 12 is an image of code expressions outlining potential algorithms used in the method of feature selection within the electronic data file of FIG. 1, in accordance with the first exemplary embodiment of the present disclosure. Specifically, FIG. 12 shows how the algorithms may be called upon and evaluated relative to their efficiency in making assignments. It may be necessary to first flatten the lexical and syntactic features that are found for each chapter.

Once the machine learning is complete, it may be useful to save the output in an array to be used in later functions. This may make it possible to access the result for each chapter at the array that it occurs in the library, and then perform tasks on that specific chapter depending upon its result.

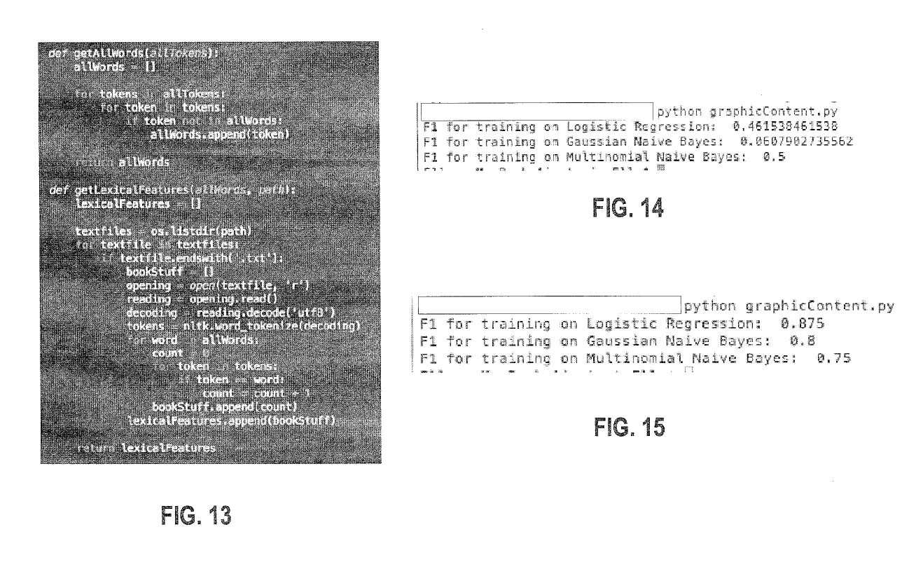

It may be possible to implement all of the tokens in the chapters. This may show if there are unknown correlations between other tokens and whether or not a chapter contained graphic content. One way to do this is to create a list of all tokens in all chapters. Then, upon accessing each chapter's text, loops may be used to get a count for how many times each word from the overall list occurs in each chapter. FIG. 13 is an image of code expressions for obtaining a count of word occurrences used in the method of feature selection within the electronic data file of FIG. 1, in accordance with the first exemplary embodiment of the present disclosure. This process may perform at a slower rate than other processes, but it may result in an increased overall accuracy. For example, FIGS. 14-15 are images of code expressions of performance of the machine learning system, in accordance with the first exemplary embodiment of the subject disclosure, where FIG. 15 uses the process of FIG. 13 and outputs high accuracy relative to FIG. 14 which uses only a word bank which contains tokens that would most likely be present in graphic content. FIG. 14 has increased speeds but overall lower performance relative to FIG. 15.

Once the information is gathered and processed through the profanity and graphic content filter at block 40, the Alchemy API software at block 30 and the feature selection module at block 35 may be used to create a summary file for each eBook, as shown at block 45. The summary file for each eBook may then be used to leverage the context of the eBook, as identified through the feature selection, to create a profile of the reader of that eBook.

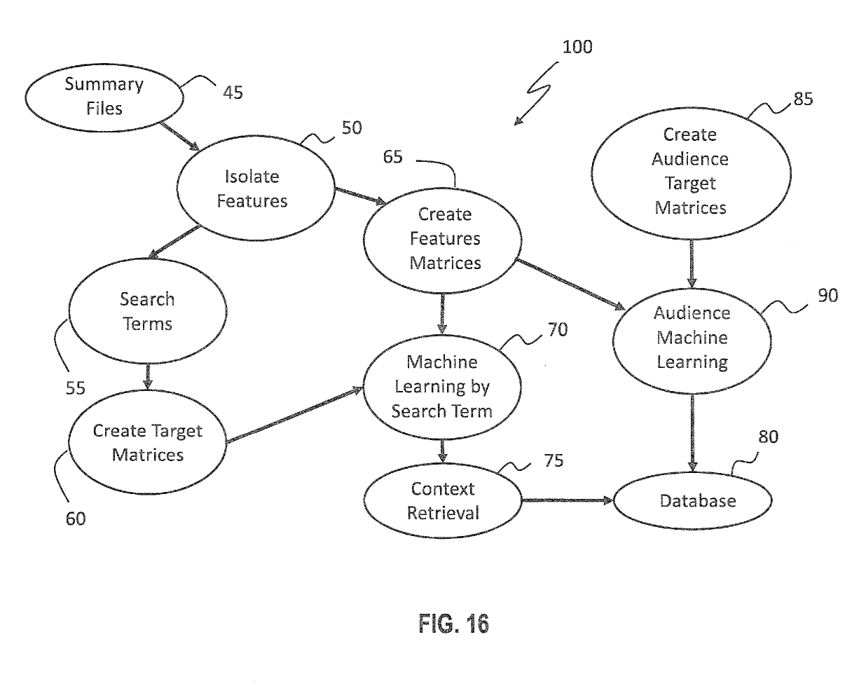

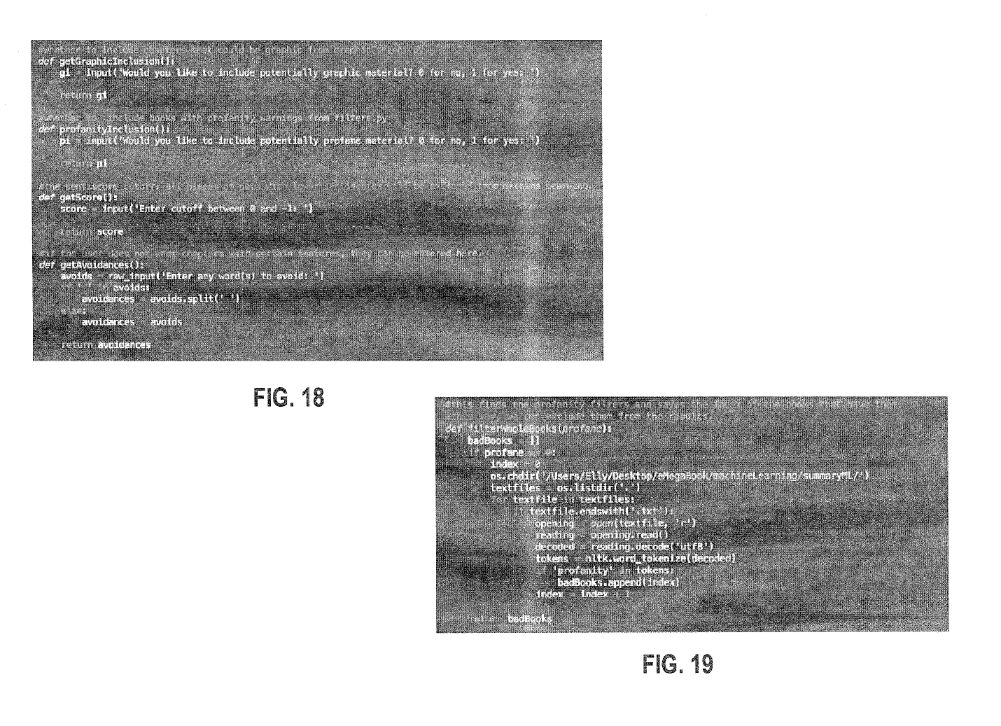

FIG. 16 is a flowchart 100 illustrating a method of the creation of feature matrices and the classifications used on them, to be saved as data, in accordance with the first exemplary embodiment of the present disclosure. In particular, FIG. 16 illustrates the overall method of feature matrix creation, machine learning classification, and context retrieval starting with the summary files derived from the process of FIG. 1, as shown at block 45 in FIG. 2. Additional details about the overall process described in FIG. 16 are discussed relative to FIGS. 18-35 herein.

The summary files are first processed to isolate features within each of the summary files, as shown at block 50. Isolating features from the summary files facilitates the ability to compare each type of data that has been gathered for each eBook or each chapter of the eBook against the same type of features for other eBooks and other eBook chapters. The process of isolating features includes gathering all of the data found for all chapters of the eBooks and dividing it into data types. Once split by data type, the data can be further examined to find correlations between the various eBook chapters. As an example, dividing the summary files by data types may include separating out each type of feature selected in block 35 (FIG. 1), e.g., so identified entities are split from identified concepts, etc. Without this division based on type, further processing of the data will include comparisons of distinct data types, e.g., the entities for one chapter of an eBook with the concepts for another chapter, which may result in inaccurate conclusions.

From block 50, the method can follow two different paths: one path that uses search terms (block 55) to generate target matrices (block 60), or a second path that creates feature matrices (block 65). In the first path, the use of search terms at block 55 refers to identifying all possible taxonomy terms that have been matched to the eBooks or the eBook chapters and then creating a list without any repeated terms. Taxonomy terms may be the broadest type of feature that the text file has, so more specific features present in the text files may be required to find correlations between features and taxonomy terms, and to link these features and taxonomy terms with the text files of additional eBooks. Accordingly, the search terms become the list of terms that can be matched to the chapters of an eBook using all other features that have been identified and isolated. The use of search terms at block 55 is effectively an extension of the data that can be achieved from simply processing the data returned from Alchemy API at block 30 (FIG. 1), because it allows for additional connections to be made between a given term and the eBooks or chapters of the eBooks based upon the data that has been gathered for them.

After block 55, the method may use target matrices in block 60 to list expected outcomes of connections. These target matrices may be used to evaluate the performance of the machine learning algorithms that are utilized later in the method to determine relevancy of the text in eBooks or chapters. In general terms, the target matrices may be used as a model for the machine learning algorithms. For example, if the searched term from block 55 is present in the data of a given eBook chapter, it would be considered a positive match to train the machine learning algorithm. In turn, the machine learning algorithm could then make predictions about relevancy using this model and the features extracted.

In the second path, the isolated features from block 50 are organized to create feature matrices at block 65 which can be used to determine how features differ between various chapters of eBooks or between different eBooks. The feature matrices may correlate a plurality of features to a plurality of eBooks or eBook chapters. Creating feature matrices docs not use search terms from block 55, but rather, it performs similar actions to those occurring in the search term block 55 for every single taxonomy term extracted from the text of the eBooks or the chapters thereof in the Alchemy API software of block 30 (FIG. 1). One version of the feature matrices may use metadata from each eBook to assign relevant audience types.

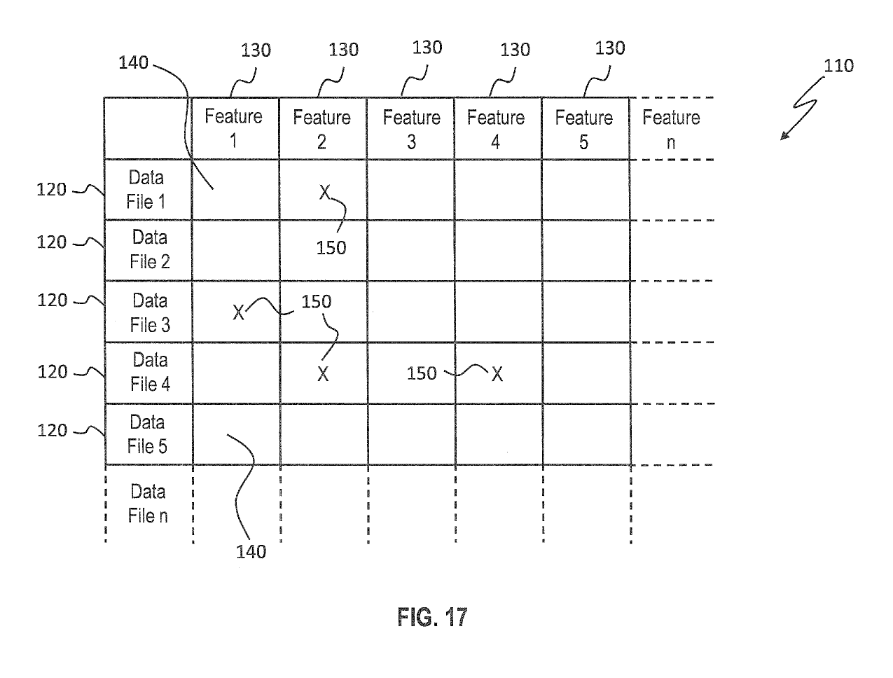

FIG. 17 is a schematic diagram of a feature matrix 110 for use in the method of feature selection and classification within an electronic data file, in accordance with the first exemplary embodiment of the present disclosure. Specifically, FIG. 17 illustrates an example of one of the possible feature matrices created in block 65 of FIG. 16. As is shown in FIG. 17, the feature matrix may be a large array having a plurality of rows 120 and a plurality of columns 130, the intersections of which each form an element box 140 in which data can be input. In the example of FIG. 17, each row may represent a single eBook, eBook chapter, or other text file, whereas each column may be represented of a possible feature. Due to the large quantity of data, the feature matrix 110 may often be a substantially large matrix that can extend to any number of columns or rows, i.e., to the n^{th} degree. The data input 150 into each element box 140 may be in a binary form to indicate the presence or absence of a particular feature from a particular data file, or it may be in another data form. As can be seen, the use of the feature matrix may result in a list of relevant features to particular eBooks, which allows the ability to see how the features are different from each cBook to eBook, or chapter to chapter of an eBook.

Referring back to FIG. 16, with the creation of search terms in block 55 and use of target matrices in block 60 or the creation of feature matrices in block 65, the output of data is then processed by one or more machine learning algorithms in block 70. In general terms, the machine learning algorithm is one or more algorithms that can be used to process the occurrences of the terms in positive matches in order to pull the context where the terms occur. Thus, the machine learning algorithms can use the data of the search terms and target matrices or the feature matrices to make connections between features and eBooks or eBook chapters, which in turn, can be used to identify audience types for each of the eBooks or eBook chapters. In order to streamline the process, several filters may be used to ensure that the occurrence of the term is in the correct sense of the word.

The machine learning algorithm may be run on any type of computerized device having a processor and a non-transitory memory. In one example, a machine learning library for a particular programming language, such as Sci-kit learn, may be used to perform the processing of the machine learning algorithm. The machine learning algorithm may include a variety of distinct or combined processes having any number of models, classifiers, and sub-algorithms. For example, the machine learning algorithm may include application of a Logistic Regression algorithm to the feature matrix of block 65 and/or may include the use of classifiers such as several types of Naïve Bayes classifiers. Many other algorithms may also be utilized, including any that are known within the field of machine learning.

When the machine learning algorithm is employed, it is possible to draw conclusions from the contextual connections made between the features and the various eBooks or chapters. For example, using the machine learning algorithm, it becomes possible to take a single search string or taxonomy term and use the feature matrix to find connections that lead the term to appear relevant to each eBook or chapter of the eBook. When the method is applied to many eBooks, each having many features, it is possible to determine relevancy of terms between eBooks, which can be used as an identifier of audience type. As an elementary example, if a number of eBooks are found to have the proper name ‘George Washington’ as being highly relevant to the context of the eBooks, it may be possible to identify a reader of those eBooks as someone interested in American history. In turn, similar eBooks on American history topics can be suggested to that person or advertising that is believed to be of high interest to them, e.g., historic collectables, can be directed to that person.

Once the terms determined to be relevant to each book and chapter arc known, it is possible to perform searches by terms and keywords within the results returned. If a term is searched that is not already saved, a first version of the machine learning algorithm may take effect and add that term to the information, making the system more robust. Accordingly, with each iteration of the machine learning algorithm, it is possible to increase its accuracy and output.

At block 75, the output of the machine learning algorithm may be processed through a context retrieval module to help ensure the safety of brands. Here, the method disambiguates the differentsenses of a particular search term to make sure that it occurs in the intended way and in a positive way. As an example, the context retrieval processing may allow for selection of particular terms when used as a noun as opposed to their use as a verb.

Once all processing is complete, the method may output the results to a database at block 80, or any other setting for storage, further processing, or other use. In one example, the database may be accessible by a system or users of the system to allow them to access the data. For example, the database may be made accessible to advertisers who can use the data to direct their advertisements to particular eBook readers. All other uses of the data produced by the method described herein n are also considered the scope of the present 1 closure.

It is further rioted that the met include features to analyze the audience of the eBooks outside eBooks themselves. For example, in block 85, audience target matrices may be created to analyze audience type to match the content of an eBook to a specific at demographic. This process is not unlike the creation of target matrices i block 60, but will include data that is characteristic of the audience. The audience demographics may include any type of demographic, such as age, sex, race, location, etc. The audience target matrices may be analyzed at block 90 by an audience machine learning algorithm using the feature matrices created at block 65 to find correlations between the semantic features of eBooks and audience

The result of this thither processing is a list of eBooks that are deemed to be relevant to each audience type that the audience machine learning algorithm is run on. This data then be sent to the database at block 80 or to any other setting for storage,further processing, or other use.

While FIGS. 16-17 provide an overview of the process employed by this disclosure, for the sake of clarity, additional figures, descriptions of the novel processing, and examples of code expressions are provided to describe various additional details, as follows.

Prior to the initial use of the processing described herein, it is necessary to populate the initial database. The database must be initially populated with at least a first set of matches between the various data input into the system or retrieved from eBook text files. For example, the initial population may include creating a first set of matches between advertising types, eBooks, and the chapters within the eBooks. These matches are what may be returned when an advertiser is querying the system for the most relevant, brand-safe locations to place their advertisement.

The first step may be to prompt users of the methodology employed herein for their desired specifications. FIG. 18 is an image of code expressions for prompting users for desired specifications, used in the method of feature selection within the electronic data file of FIG. 16, in accordance with the first exemplary embodiment of the present disclosure. As shown, specifications that are user-set may include whether or not to include eBooks and chapters with graphic content or profanity in the results and if there are any words to avoid in finding potential matches. To gather these preferences, input commands can be used when the program is first run.

One of the most significant features is that of the score. The score may allow a user to determine how positive or negative a feature of an eBook or chapter should be regarded in context to be included in the match. For example, if the user were to specify a score of 0.75, any features that appear in the text, but have a score that is lower than 0.75 will not be included in the machine learning algorithm's assignment.

Once the user specifications have been set, it may then be necessary to filter out any graphic or profane matches, if the user does not want them. To filter out eBooks with profanity summary files for each book may be opened and checked for the profanity warning on the last line. Because summary files and the eBook text files are saved in the same order in their respective folders, the indexes of the books that contained a warning may be saved. FIG. 19 is an image of code expressions for filtering out graphic or profane matches, used in the method of feature selection within the electronic data file of FIG. 16, in accordance with the first exemplary embodiment of the present disclosure. Once indexes of eBooks with warnings are saved, rows in the feature matrix that correspond to these may later be discarded before the machine learning takes place. This way, it may be ensured that unwanted content will not be returned to the user.

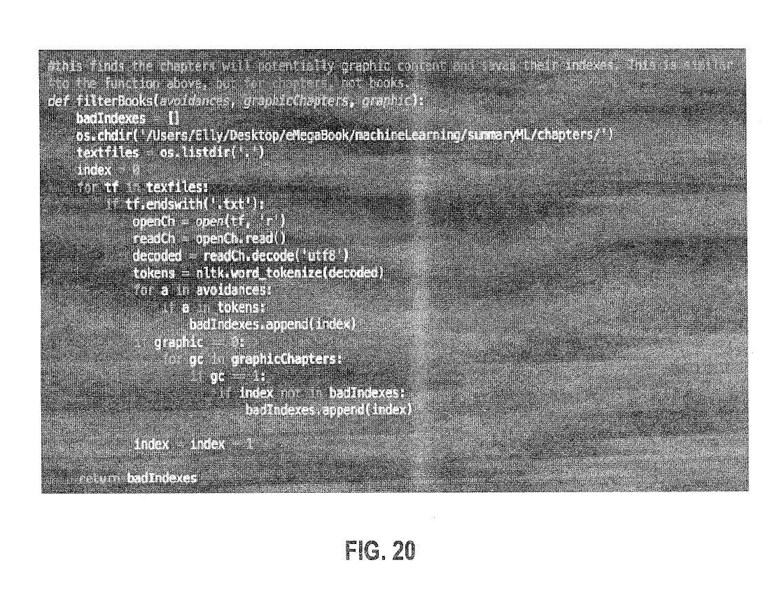

The strategy for excluding graphic content may be similar to that of excluding profanity. FIG. 20 is an image of code expressions for filtering out graphic matches, used in the method of feature selection within the electronic data file of FIG. 16, in accordance with the first exemplary embodiment of the present disclosure. The indexes of chapters with a potential for graphic content may be saved in earlier stages of development. For this reason, it is possible to create a list of bad indexes for chapters to be excluded in the coming machine learning steps. FIG. 20 also illustrates a process for handling for word avoidances. In order to exclude chapters with words determined not to be brand safe by a potential advertiser using the system, the text belonging to each chapter must be accessed. Once the chapters are opened and read, they may be examined for the undesired tokens. If present, that chapter's index may be added to the overall list of bad chapter indexes.

Once all user-specifications are completed, the majority of the process can take place. Due to the fact that the processing occurs based upon both books and the chapters within the books, the algorithm needs to be run on each, as their features differ. It may be beneficial to focus upon individual chapters, as there is naturally a much larger number of them. The initial necessity may be to isolate features (block 50, FIG. 16) by separating all of the chapter entries within each book's summary file so that each type of data can be easily accessed. This may be completed by opening each of the summary files and then splitting the text within them on blank lines. The items in the resulting list may each represent a single chapter within the larger list for the whole book. By the end of this process, there may be one primary list, which contains one entry for each book, with each book entry containing an entry for each of its chapters.

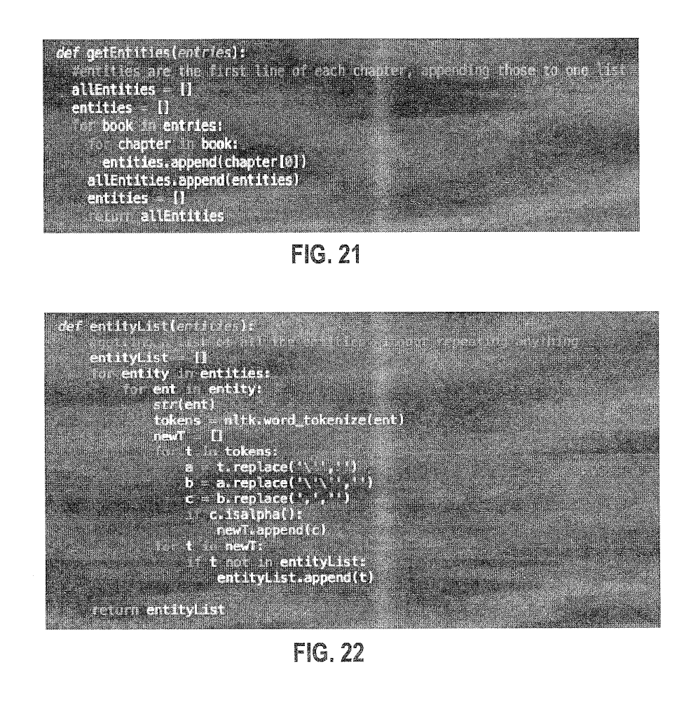

FIG. 21 is an image of code expressions for extracting the entities from the summary files (block 45 in FIG. 16) used in the method of feature selection within the electronic data file of FIGS. 1 and 16, in accordance with the first exemplary embodiment of the present disclosure. As, shown, all items belonging to each of the data types (entities, keywords, concepts, relations, and taxonomy terms) are grouped together. Because each entry may contain data in the same order, each entry can be accessed for every chapter by pulling data from a single index. In the example of FIG. 21, it is known that the entities were the first type of data extracted from Alchemy API software, so the first line is pulled from each chapter's data in order to compile all data of that type. It may then he stored in a list for later use.

When data is pulled from each chapter, it may still be in the format of the AlchemyAPI software output. This means that the SentiScore, type, subject, etc. may still be in the list with each item. Because the items themselves could be used as features, a master list function for each data type may be created. This function may tokenize each group of data types. FIG. 22 is an image of code expressions for tokenizing each group of data types used in the method of feature selection within the electronic data file of FIG. 16, in accordance with the first exemplary embodiment of the present disclosure. As shown in FIG. 22, the function may then isolate the first entry in each item's list. If it is not already present, that item may be then added to the final master list.

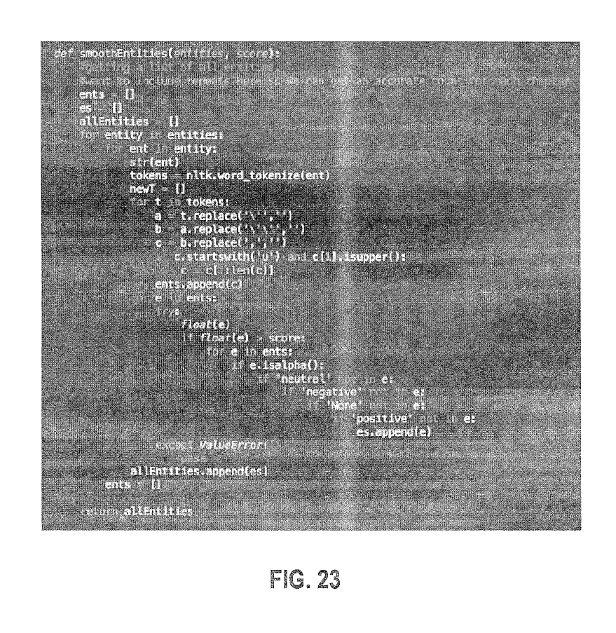

In order to use the data present in each chapter's entry, it may be necessary to format it so that it can be easily compared to the master list. As with the previous functions, each item may be isolated from the extra information that is present with it. Here, the numerical score following the item is isolated and converted to a float. It may then be compared to the user set score. If it is equal to or greater than the score, that feature will show as present for the chapter. Once a chapter has been evaluated, its list is added to an overall list of chapter's results. FIG. 23 is an image of code expressions for this process used in the method of feature selection within the electronic data file of FIG. 16, in accordance with the first exemplary embodiment of the present disclosure.

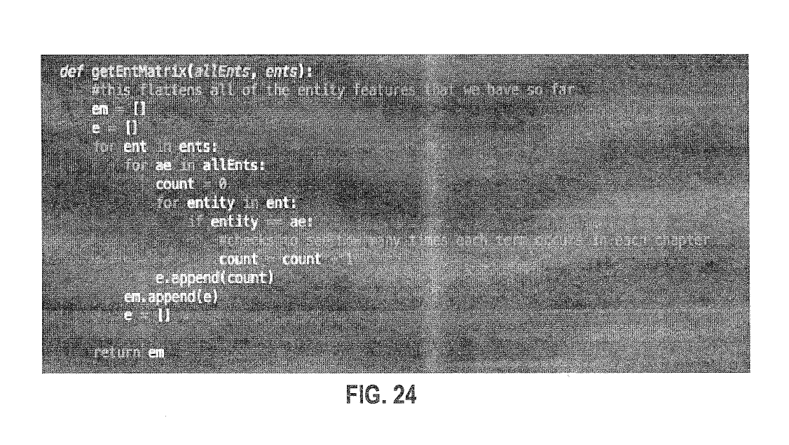

Finally, in order to use this master list in the final feature matrix, each chapter should be examined to see if it contains each item in the list. If the item is found, a ‘one’ designation is appended to the list. If not, a ‘zero’ designation is appended. The resulting list of ones and zeros may be used in the feature matrix (block 65 in FIG. 16). To compile this list, each chapter's specific data may be accessed and checked for each item in the master list. FIG. 24 is an image of code expressions for accessing and checking for each entity item relative to the master list used in the method of feature selection within the electronic data file of FIG. 16, in accordance with the first exemplary embodiment of the present disclosure.

The process described in FIGS. 21-24 is described relative to entities, but it may be repeated for each of the data types that have been collected. The resulting outcome may be a two-dimensional matrix for each type of data, each of which contains a list for each chapter's results. In one example where five data types are used, i.e., entities, keywords, concepts, relations, and taxonomy terms, the resulting outcome may be five two-dimensional matrices.

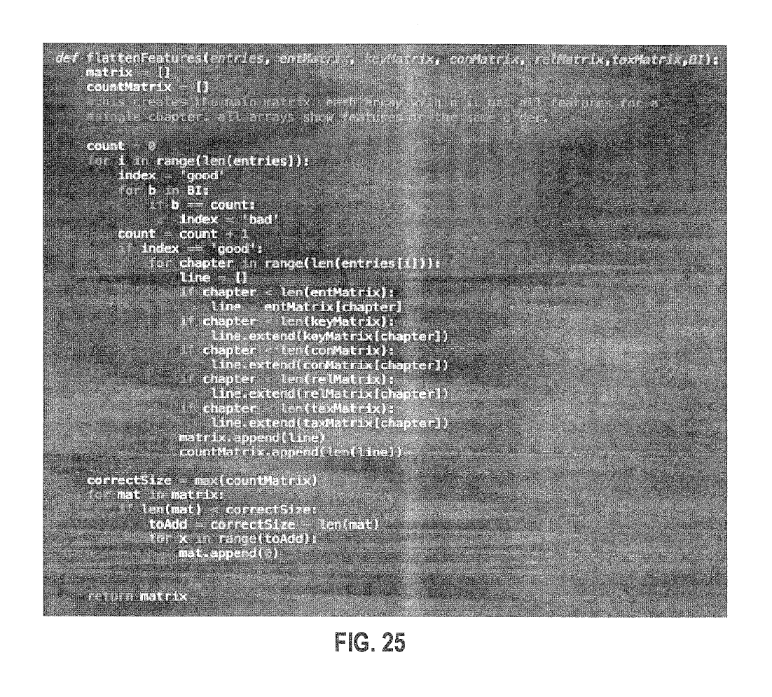

Under this example, the completion of the five initial two-dimensional matrices may lead to the need for a single matrix containing all information for a particular chapter within a single row in the matrix. This single matrix may he achieved by first looping through a range equivalent to the number of chapters in the library. Within each iteration of the loop, the list at the index of the iteration may be pulled from each matrix. These lists may then be combined and appended to the final matrix. At the end of the process, the result may be one matrix with the same number of rows as chapters in the library. Each row may contain all of the information for each data type in a given chapter. FIG. 25 is an image of code expressions for combining each data type matrix into a single matrix, used in the method of feature selection within the electronic data file of FIG. 16, in accordance with the first exemplary embodiment of the present disclosure.

Once the feature matrix (block 65, FIG. 16) has been established, a target matrix must be created, as described relative to block 60 in FIG. 16. For an initial population of the database, the list of taxonomy terms that had been gathered from each chapter may be utilized as keywords. The machine learning algorithms could, therefore, be used in order to pair each taxonomy term with the chapter(s) that were determined to be most relevant or positively related to it.

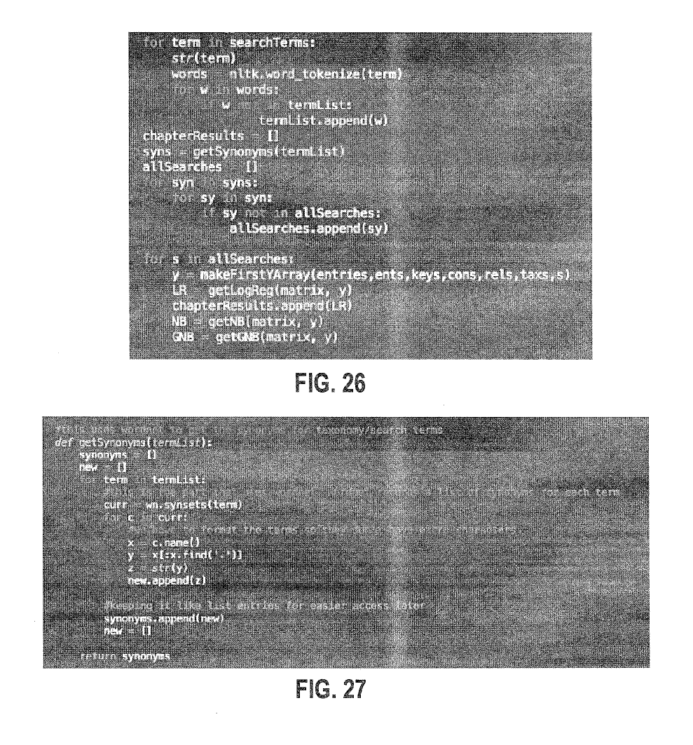

FIG. 26 is an image of code expressions for the overall process of calling the machine learning functions for each of the taxonomy terms, used in the method of feature selection within the electronic data file of FIG. 16, in accordance with the first exemplary embodiment of the present disclosure. As shown, the list of taxonomy terms may be tokenized so that each word could be accessed individually. In order to make the search process more accessible to different users, synonyms for each taxonomy term in the terms may be chosen to be searched.

Next, synonyms may be gathered through NLTK's Word Net interface. FIG. 27 is an image of code expressions for a function that is called to collect synonyms, used in the method of feature selection within the electronic data file of FIG. 16, in accordance with the first exemplary embodiment of the present disclosure. Within the function, each word in the list of taxonomy terms may be accessed through a for-loop. In each iteration, the Word Net Synset (sets of synonyms) of the term may be found. It may then be formatted so that any extra characters are removed from the list and the synonyms appear like the taxonomy terms. Once finished, the taxonomy term and its synonyms are added to the final search list. This is the list that may be iterated through for machine learning in FIG. 26.

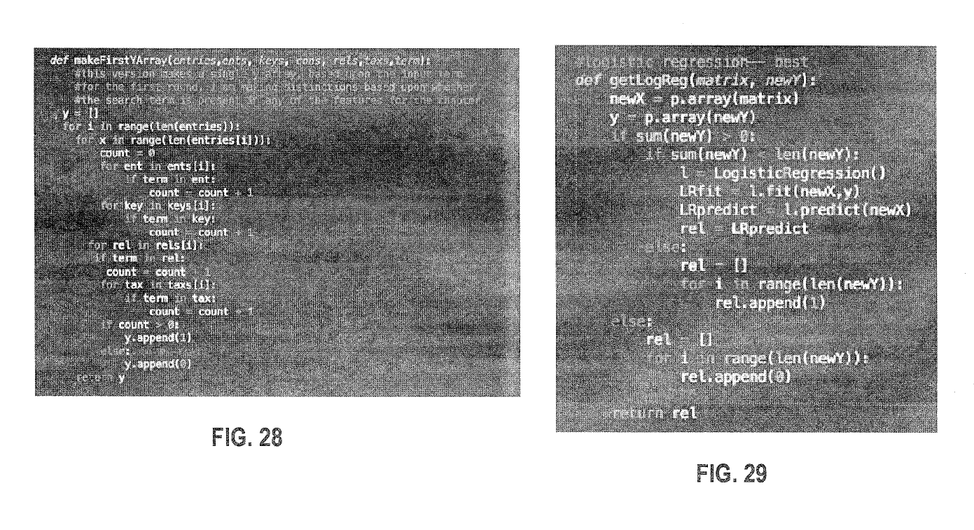

Inside each iteration of the list of words to be assigned to their relevant chapters, the function to create a target matrix may also be called upon. FIG. 28 is an image of code expressions for a function to create a target matrix, used in the method of feature selection within the electronic data file of FIG. 16, in accordance with the first exemplary embodiment of the present disclosure. In order to create the target array for each term, the chapter entries and the master list for each data type must be determined. Then, each chapter's data is examined to determine whether the word in question appears in the specific chapter's data. If it does not, then a ‘zero’ designation is returned for that chapter. If it does appear, a ‘one’ designation is returned.

This may result in a list of ones and zeros, which has one row and is the length of the total number of chapters. This format may prove to be a simple way to evaluate whether or not a chapter is relevant, as variables such as presence of a synonym or similar topic could lead to a false negative. For this reason, additional scrutiny may be used in determining the initial success of the machine learning models.

Now that the feature matrix (block 65, FIG. 16) and the target matrix (block 60, FIG. 16) are both available for the specific term in question, the machine learning algorithms at block 70 in FIG. 16 can take place. FIG. 29 is an image of code expressions for Logistic Regression used in the method of feature selection within the electronic data file of FIG. 16, in accordance with the first exemplary embodiment of the present disclosure. While a Logical Regression model was used, other models which may be used including Multinomial Naïve Bayes, and Gaussian Naïve Bayes, among others. When the algorithms are first run, the data may be fit into a training set's feature and target matrices. Then, a predict function on the testing data may be run.

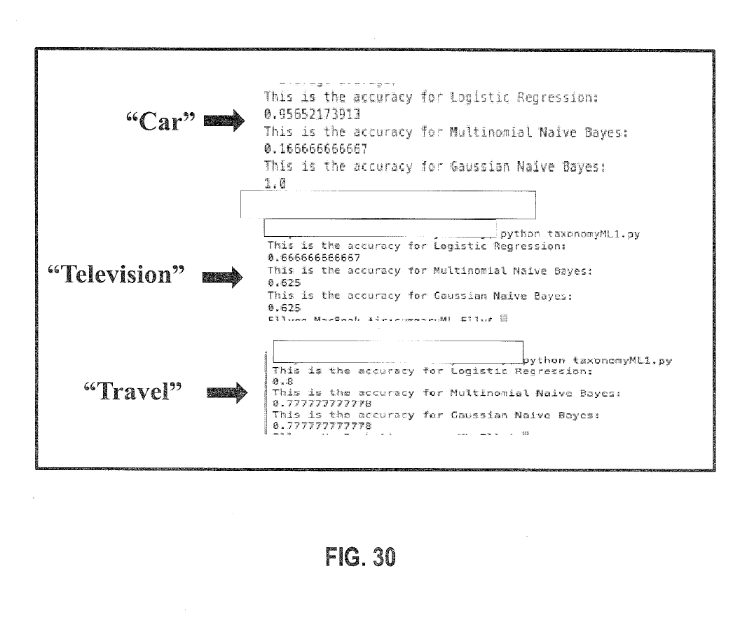

The use of a specific model or algorithm may be selectable based on the desired specifics of the outcome of the processing. To initially determine which of the models may be preferable, all three algorithms (Logical Regression, Multinomial Naïve Bayes, and Gaussian Naïve Bayes) can be run with three different term searches. This may he done in order to evaluate the performance of the models. As an example of evaluating performance of the models, FIG. 30 is an image of code expression outputs for initial tests of various models used in the method of feature selection within the electronic data file of FIG. 16, in accordance with the first exemplary embodiment of the present disclosure. As shown, the first search is for the keyword “car,” the second is for “television,” and the third is for “travel.” These are all words that appear in the taxonomy list. Their F1 score ranged from about 16% accuracy with Multinomial Naïve Bayes to 95% accuracy with Logistic Regression, with the Logistic Regression algorithm being the most often correct, as reflected in its F1 score.

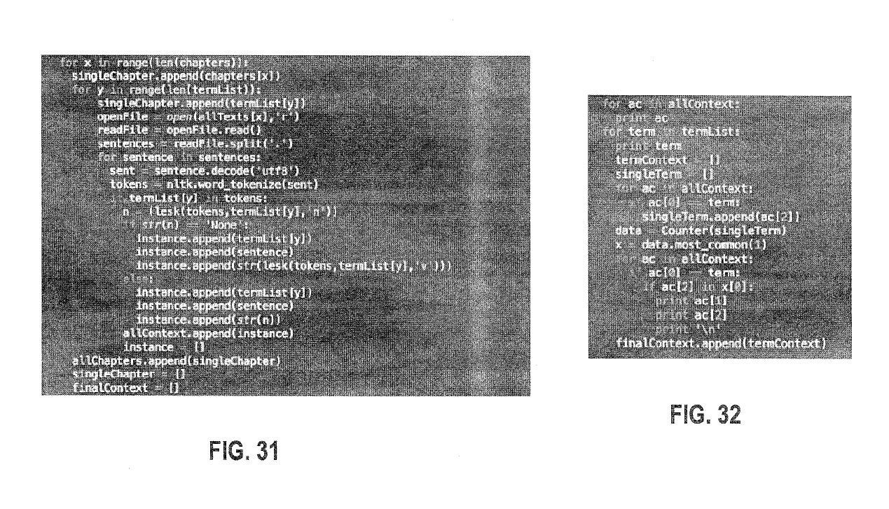

To ensure that the machine learning algorithms are as accurate as possible, context retrieval (block 75, FIG. 16) may be employed. In particular, context retrieval may be used before the results of the machine learning algorithms arc saved in the database. The context retrieval functions may analyze the sentence surrounding uses of the term that is being searched. In order to do this, the text files for chapters with indexes indicating a positive match may be accessed. FIG. 31 is an image of code expression for accessing text files for chapters with indexes indicating a positive match, used in the method of feature selection within the electronic data file of FIG. 16, in accordance with the first exemplary embodiment of the present disclosure. As shown in FIG. 31, the tokens in each chapter's text may then he compared to the term in order to find occurrences in the chapters. Once matches are found, the sentence that each of the matches belongs to may be saved.

It is cautioned that not all uses of a particular word may, be uses of the same sense of that word. For this reason, word sense disambiguation may be employed. For example, a Lesk algorithm may be used effectively to find the correct sense of a word. Using the Lesk algorithm, the noun sense of the word may first be used, as a vast majority of the taxonomy terms are nouns. If no noun senses are returned, the verb sense of the word may be used. This information may be saved alongside each sentence with a match. Once all sentences containing matches and the word sense of each match has been saved, a process may be used to determine which sense of the word is most likely to be correct. FIG. 32 is an image of code expression for processing a word sense, used in the method of feature selection within the electronic data file of FIG. 16, in accordance with the first exemplary embodiment of the present disclosure. One assumption that may be employed with the process of FIG. 32 is that if a chapter or book was deemed to be positively relevant to the term, then the most frequently occurring sense of the term is most likely the correct one. With this reasoning, the process of FIG. 32 may be used to access the word sense of each occurrence and locate the most frequently occurring sense. Then, only the cases in which the most frequently returning sense of the word being used should be returned to the user.

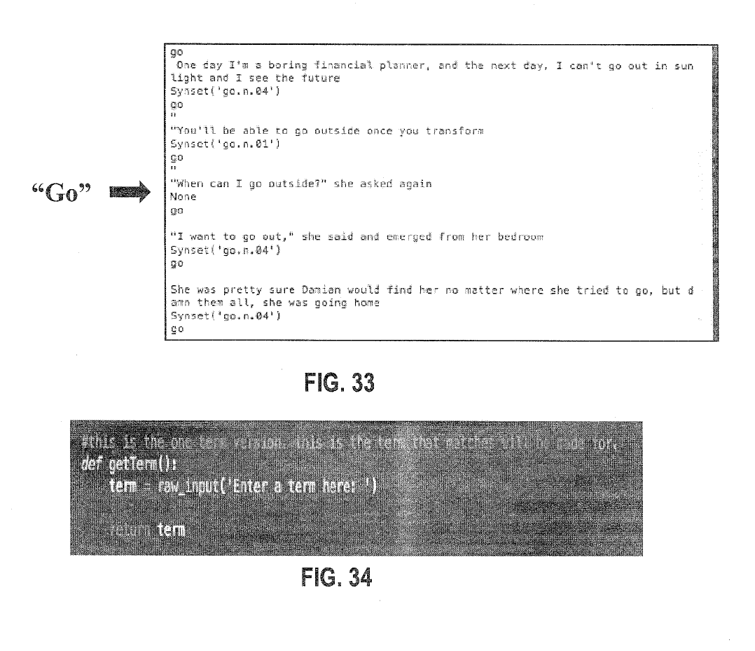

FIG. 33 is an image of code expression outputs of the process of FIG. 32, in accordance with the first exemplary embodiment of the present disclosure. Specifically, FIG. 33 shows the process of FIG. 32 with the word ‘go’. As shown, several different senses of the word ‘go’ were returned originally, with only the most common now included in the results.

The machine learning models may account for at least four different scenarios. These include chapter matches, overall book matching, database initializing with all current data, and single term searching. The difference between chapter and overall book searching may be negligible, as they may both be approached in the same manner. There are simply fewer entries for overall books than individual chapters. It may be beneficial to separate the database population methods from the single search methods in order to keep run time down on the single search method, as users will he primarily interested in the single search function and it may be best to avoid unnecessary lags by repopulating the database every time something is searched for.

The system and method described herein may be initially populated with terms and eBook text files. Over time and over a period of use, processing of the initially populated terms stored in the database may be improved through the machine learning algorithms employed. However, when a user searches for a term or terms which are not already populated in the database, it is necessary for that term or terms to be added to the database, such that matches between the newly added term or terms and the eBook text tiles can be created. If a new term is presented, where the new term is not in the database, a single search term version of the processing may be employed. This single search term version (also called ‘second portion’ of the system) may be faster than the original populating process of terms in the database. This is due to the fact that it may only run the machine learning algorithms for a single term, as opposed to the previously described processing which runs for every single term in the current database.

As an example of this processing, FIG. 34 is an image of code expression for a single search term used in the method of feature selection within the electronic data file, in accordance with the first exemplary embodiment of the present disclosure. Specifically, FIG. 34 illustrates the new search term at the command line (‘Enter a term here: ______’). Then, the WordNet SynSet function may be run on the input term, just as with the previous words from the database. In this way, if a synonym of the input term is located in the feature set of a chapter or book, it may still be matched to that entry. The machine learning algorithm may then be run on the same feature matrix, as previously described. Because a potential keyword is being matched to the information within a chapter or book, similar to the original population of the database, it may be beneficial to analyze the same features for new terms as were analyzed for the original population. The target matrix may also he created in the same way as the initially populated terms. This processing may ensure that as new terms are added, they are being evaluated equivalently to those that are already in the database. The output of the single search term's machine learning may be added to the MySQL database, such that the database will continue to grow as more searches arc made, and the number of times that it becomes necessary to call upon machine learning will decrease. Once many searches have occurred and are saved in the database, it may be more likely that the term a new user will search is already located with results in the database, which may eventually cut down on the run time.

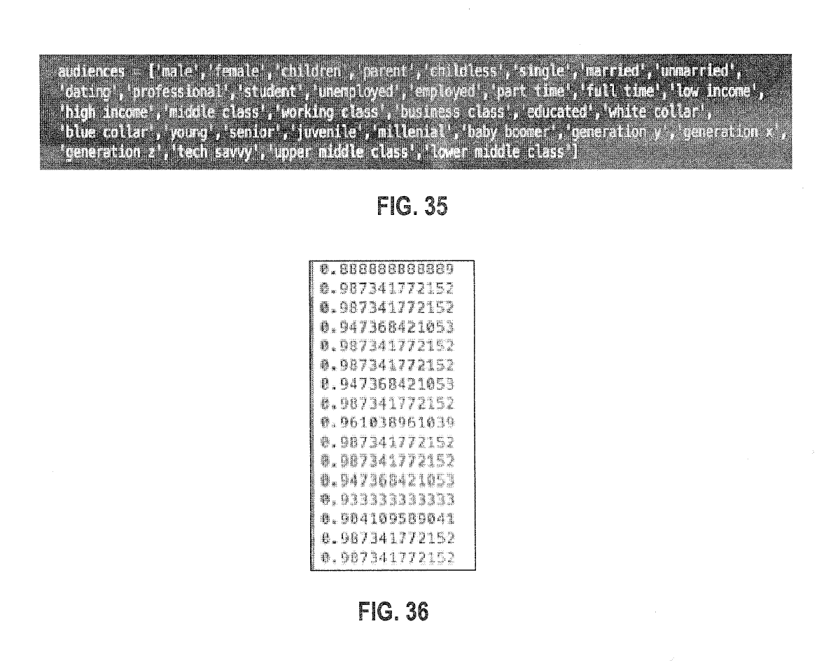

It may also be beneficial to incorporate potential audience types into the methodology used to better direct specific advertisements to the correct audience type. It may be possible to incorporate audience type by creating different types of target matrices for each eBook in its entirety. Initially, it is necessary to identify and assign potential audience types. A list of approximately 40 terms was derived, although additional or different terms could also be used. The terms could be used in a similar manner to the search terms previously described. FIG. 35 is an image of code expression for potential audience type term used in the method of feature selection within the electronic data file, in accordance with the first exemplary embodiment of the present disclosure.

With these terms, target matrices can be made for all of the eBooks currently located in the library. In these matrices, a ‘1’ may represent the eBook in question being relevant to a particular audience type, and a ‘0’ being irrelevant to that audience type. For example, of an initial set of approximately 35 books, approximately 30 of them may be reserved for training. In order to perform training on the 30 books that are held aside, a similar feature matrix to that previously described may be used. This includes the most relevant entities, keywords, concepts, relations, and taxonomy terms to each book that are gathered through Alchemy API software. A reason to use the same or a substantially similar feature matrix may be to identify if the features would have any correlation to potential audience types. If so, it could act as a novel way to make suggestions on audience type.

Once the feature matrix and target matrices have been established, machine learning may be run on every audience type. Machine learning will train on the entire feature matrix of the training set and the target matrices of the eBooks being tested to find correlations there between. It may then make predictions for the books being tested on and assign them a ‘1’ if they are relevant to the term and a ‘0’ if they are not. The results of this process for the first few audience terms are shown in FIG. 36, which is an image of code expression outputs for audience type determination used in the method of feature selection within the electronic data file, in accordance with the first exemplary embodiment of the present disclosure. As shown in FIG. 36, most of the outcomes may be at least 90% accurate, which may confirm correlation with features found in earlier stages of the process. This data may be populated into the database with the machine learning program and matching of books to audience types may only need to be run when new books are added to the library.

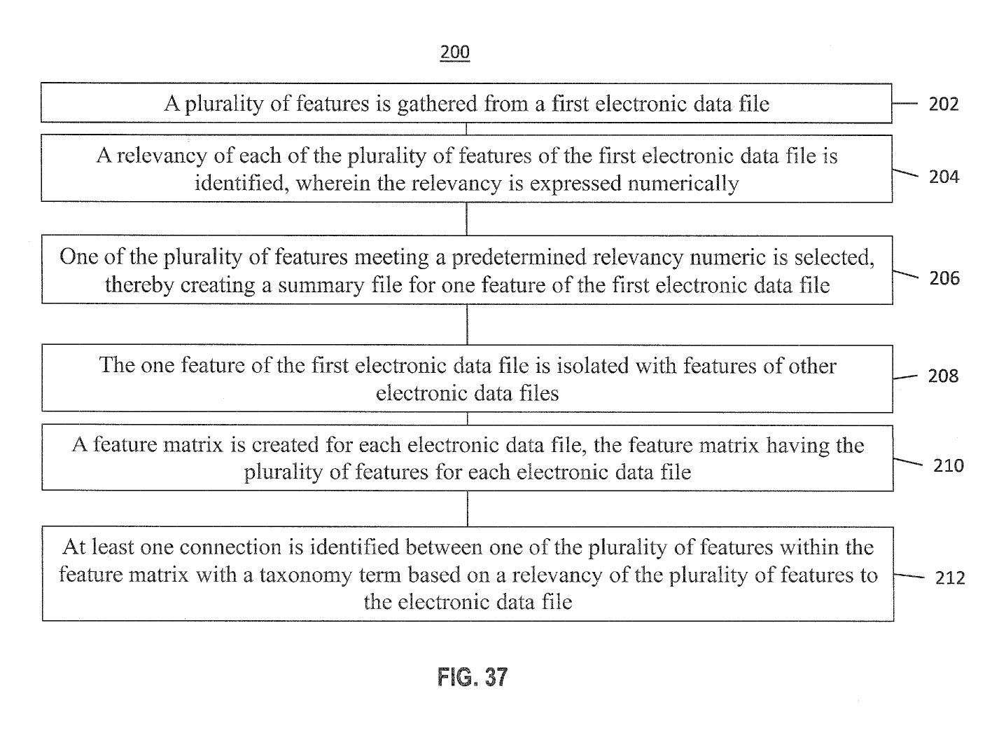

FIG. 37 is a block flowchart 200 illustrating a method of feature selection and classification within an electronic data file, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a plurality of features is gathered from a first electronic data file. A relevancy of each of the plurality of features of the first electronic data file is identified, wherein the relevancy is expressed numerically (block 204). One of the plurality of features meeting a predetermined relevancy numeric is selected, thereby creating a summary file for one feature of the first electronic data file (block 206). The one feature of the first electronic data file is isolated with features of other electronic data files (block 208). A feature matrix is created for each electronic data file, the feature matrix having the plurality of features for each electronic data file (block 210). At least one connection is identified between one of the plurality of features within the feature matrix with a taxonomy term based on a relevancy of the plurality of features to the electronic data file (block 212). Additionally, the method may include any of the steps, processes, or functions described relative to any other figure of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may he made to the above-described embodiment(s) of the disclosure without departing substantially from the spirit and principles of the disclosure. All such modifications and variations arc intended to be included herein within the scope of this disclosure and the present disclosure and protected by the following claims.

What is claimed is:

1. A method of feature selection within an electronic data file, the method comprising the steps of:
identifying a plurality of features from a first electronic data file using textual data from the first electronic data file;
identifying a relevancy of each of the plurality of features of the first electronic data file, wherein the relevancy is expressed numerically;
selecting at least one of the plurality of features meeting a predetermined relevancy numeric, thereby creating a summary file for the at least one of the plurality of features of the first electronic data file;
isolating the at least one feature of the first electronic data file with features identified from other electronic data files using textual data within the other electronic data files;
creating a feature matrix for each electronic data file to correlate the plurality of features to each electronic data file; and
identifying at least one connection between one of the plurality of features within the feature matrix with a searched string based on a relevancy of the plurality of features to the electronic data file.

2. The method of claim 1, wherein the electronic text file further comprises at least one of: an eBook text file, an EPUB file, a BBeB file, a .pdb file, a .fb2 file, a .xeb file, and a .ceb file.

3. The method of claim 1, wherein identifying the plurality of features from the first electronic data file using textual data from the first electronic data file further comprises splitting the electronic data file into discrete portions, wherein the discrete portions further comprise at least one of chapters of the first electronic data file and single lines of text of the first electronic data file.

4. The method of claim 1, wherein the plurality of features further comprise at least one of an entity, a keyword, a concept, a relation, a taxonomy term, a character, a setting, and an object.

5. The method of claim 1, wherein the relevancy is expressed numerically with a relevancy score, wherein the relevancy score is representative of a number of times one of the plurality of features is present within a discrete portion of the electronic data file.

6. The method of claim 1, wherein isolating the at least one feature of the first electronic data file with features identified from other electronic data files using textual data within the other electronic data files by calculating a relation score for the at least one feature of the first electronic data file based on a negative or positive relation of the at least one feature to surrounding text within a discrete portion of the electronic data file.

7. The method of claim 1, wherein creating the summary file includes:
calculating a relevancy score and a relation score for the at least one feature;
appending the relevancy score and the relation score into a multidimensional list; and
appending the multidimensional list to the summary file.

8. The method of claim 1, further comprising filtering the textual data of the first electronic data file for instances of profanity using a tokenizer.

9. The method of claim 8, further comprising adding a profanity warning to the summary file of the first electronic data file, wherein a level of the profanity warning is based on a number of instances of profanity within the textual data of the first electronic data file.

10. The method of claim 1, further comprising filtering violent and graphical textual data from the first electronic data file with at least one of a Logistic Regression algorithm, a Gaussian Naïve Bayes algorithm, and a Multinomial Naïve Bayes algorithm.

11. A computerized system of feature selection within an electronic data tile, the computerized system having a processor capable of performing the steps of:
identifying a plurality of features from a first electronic data file using textual data from the first electronic data file;
identifying a relevancy of each of the plurality of features of the first electronic data file, wherein the relevancy is expressed numerically;
selecting at least one of the plurality of features meeting a predetermined relevancy numeric, thereby creating a summary file for the at least one of the plurality of features of the first electronic data file;
isolating the at least one feature of the first electronic data file with features identified from other electronic data files using textual data within the other electronic data files;
creating a feature matrix for each electronic data file to correlate the plurality of features to each electronic data file; and
identifying at least one connection between one of the plurality of features within the feature matrix with a searched string based on a relevancy of the plurality of features to the electronic data file.

12. The system of claim 11, wherein the electronic text file further comprises at least one of: an eBook text file, an EPUB file, a BBeB file, a .pdb file, a .fb2 file, a .xeb file, and a .ceb file.

13. The system of claim 11, wherein identifying the plurality of features from the first electronic data file using textual data from the first electronic data file further comprises splitting the electronic data file into discrete portions, wherein the discrete portions further comprise at least one of chapters of the first electronic data file and single lines of text of the first electronic data file.

14. The system of claim 11, wherein the plurality of features further comprise at least one of an entity, a keyword, a concept, a relation, a taxonomy term, a character, a setting, and an object.

15. The system of claim 11, wherein the relevancy is expressed numerically with a relevancy score, wherein the relevancy score is representative of a number of times one of the plurality of features is present within a discrete portion of the electronic data file.

16. The system of claim 11, wherein isolating the at least one feature of the first electronic data file with features identified from other electronic data files using textual data within the other electronic data files by calculating a relation score for the at least one feature of the first electronic data file based on a negative or positive relation of the at least one feature to surrounding text within a discrete portion of the electronic data file.

17. The system of claim 11, wherein creating the summary file includes:
calculating a relevancy score and a relation score for the at least one feature;
appending the relevancy score and the relation score into a multidimensional list; and
appending the multidimensional list to the summary file.

18. The system of claim 11, further comprising filtering the textual data of the first electronic data file for instances of profanity using a tokenizes.

19. The system of claim 11, further comprising filtering violent and graphical textual data from the first electronic data file with at least one of a Logistic Regression algorithm, a Gaussian Naïve Bayes algorithm, and a Multinomial Naïve Bayes algorithm.

20. A method of contextual feature selection within a computerized eBook text file, the method comprising the steps of:
identifying a plurality of features from a plurality of eBook text files, respectively, using textual data from each of the plurality of eBook text files, wherein the plurality of features are one of an entity, a keyword, a concept, a relation, and a taxonomy term;
calculating a numerical relevancy score for each of the plurality of features of each of the plurality of eBook text files relative to a discrete portion each of the plurality of eBook text files, respectively;
creating a summary file each of the plurality of eBook text files and for each of the plurality of features having a numerical relevancy score greater than a predetermined relevancy numeric;
isolating at least one of the plurality of features of one of the plurality of eBook text files;
correlating the at least one isolated feature of the one eBook with other isolated features of other eBooks based on a data type of the isolated features to thereby create a feature matrix for each of the plurality of eBook text files; and
identifying at least one connection between one of the isolated features within the feature matrix with a searched string based on a relevancy of the isolated feature to the discrete portion of the eBook text file.
